(19) United States
(12) Patent Application Publication
(10) Pub. No.: US 2010/0012639 A1
(43) Pub. Date: Jan. 21, 2010

(54) SYSTEMS AND METHODS FOR HORIZONTAL AXIS BASED FOOD STIRRING

(75) Inventors: Phillip Kevin Merrell, Huntington Beach, CA (US); Dan Dvorak, Huntington Beach, CA (US)

Correspondence Address: KNOBBE MARTENS OLSON & BEAR LLP, 2040 MAIN STREET, FOURTEENTH FLOOR, IRVINE, CA, 92614, US

(73) Assignee: ARLOESI, Huntington Beach, CA (US)

(21) Appl. No.: 12/505,393

(22) Filed: Jul. 17, 2009

Related U.S. Application Data
(60) Provisional application No. 61/082,088, filed on Jul. 18, 2008.

(51) Int. Cl. A47J 27/00

(52) U.S. Cl. 219/201; 99/348

(57) ABSTRACT

A food cooking device includes a base housing defining an interior space and a heating element within the interior space. The heating element provides a source of heat for cooking food. A bowl is separate from the heating element and is positionable into the interior space with the heating element between the base housing and the bowl. The bowl may have a concave bottom wall defining an exterior surface and an interior surface, the interior surface defining a food space for receiving food for cooking. The bowl further has an upper rim defining an opening to the food space. A lid cooperates with the bowl to close the opening to the food space. A stirrer is positionable within the food space, the stirrer being rotatable within the food space about a substantially horizontal axis.

### RELATED APPLICATION

This application is related to provisional application No. 61/082,088, filed Jul. 18, 2008, pending, the entirety of which is incorporated by reference herein.

### BACKGROUND OF THE INVENTION

1. Field of the Invention

Embodiments of the present invention relate generally to a food container with a unique stirring assembly, and more particularly to a method and system for stirring of food and/or automatically cooking food.

2. Description of the Related Art

A wide variety of automatic cooking devices exist in the prior art, including, for example, devices which automatically cook bread, rice, soups, and popcorn, with little effort required of the user other than placing the ingredients within the device and turning it on. Automatic cooking devices allow the user to reap the health and flavor benefits of home-cooked food without having to invest a high amount of time or effort into the preparation of said food.

In today's increasingly health conscious society, people want to incorporate healthier meals, such as meat and vegetable stir-fry meals, into their diets. The problem that these people face is dedicating the time to cooking a healthy meal. There is a plenitude of pre-packaged frozen vegetables and pre-cut meats that can be used to create meals, but the user must still dedicate the time to standing over the stove and cooking the food.

One challenge for an automatic cooking device is stirring the food effectively enough so that it gets thoroughly cooked. In some cookers the food never gets turned over. The food cooks on one side only and can end up being burned on the side in contact with the pan surface while the other side is still raw.

### SUMMARY OF THE INVENTION

In some embodiments of the invention, a system for stirring food about a horizontal axis comprises a container and a stirring paddle mounted horizontally. In some embodiments, a system for stirring food about a horizontal axis comprises a container, a stirring paddle mounted horizontally, a drive shaft that connects to the end of the paddle to transfer stirring motion, and a drive device. In some embodiments, the drive device may be either manual or automatic, such as a hand crank or an electric motor.

In some embodiments, a container surface may be shaped and the stirring paddle mounted and matched in such a way that the paddle maintains a, generally, constant gap between its edge and the container while in the portion of the stirring cycle where the container envelopes the paddle. One skilled in the relevant art will appreciate that, in some embodiments, the container may be a variety of shapes to suit various needs.

One skilled in the art will also appreciate that the stirring paddle may come in a variety of shapes. In some embodiments, it may be a solid surface, intended for consistently moving all of the food. In some embodiments, it may be more porous so that only a portion of the food gets flipped over with each revolution of the paddle. In some embodiments, it can have edge treatments that are, generally, non-abrasive and, generally, in constant contact with the container rather than having a constant gap. It will be appreciated by one skilled in the art that embodiments will also include various suitable combinations of the aforementioned features, such as paddles that are partly porous and partly solid, or paddles that maintain a gap for periods of the stirring cycle or over portions of the container and that do maintain more contact for other periods or over other portions.

In some embodiments, a system for automatically stirring food while cooking comprises a housing, a removable cooking surface (which acts as the container mentioned previously) contained within the housing, and a heating element which heats the cooking surface to a temperature suitable for cooking food. The system may also comprise a stirring paddle which is bounded by the cooking surface, a drive shaft which protrudes through the edge of the cooking surface to connect to the paddle for turning it, a gear train, a motor and/or control system.

In some embodiments, the stirring paddle may rotate about a horizontal axis, so that it not only stirs the food but scoops it up and flips it over throughout the cooking process. In some embodiments, the paddle can be controlled in such a way that the motion of the paddle is independent of the heating element being powered on/off In some embodiments, the paddle may be attached to the drive shaft in such a manner as to make removal and installation fast and easy. This may be accomplished through a clip, quick-release, or other suitable system. In some embodiments, the paddle may be shaped to match the contour of the bowl such that, generally, the food within the bowl gets moved during the cooking process and, generally, the food is not stranded on the cooking surface, which may cause burning.

In some embodiments, the cooking surface may be a removable element. This may allow, for example, for the cooking surface to be cleaned independent of the rest of the apparatus. This may permit washing of the cooking surface by hand or in the user's dishwasher.

In some embodiments, the gear train may be positioned such that the gear attached to the drive shaft and the gear attached to the motor automatically come into suitable contact with each other for, generally, full operation when the user places the removable cooking surface into the apparatus housing.

In some embodiments, the heating element may be either electric, gas, or some other suitable cooking energy. The heating element is controlled by a suitable control system, which may be a simple on/off control. Preferably, however, the control system allows temperature adjustment of the heating element. In some arrangements, the control system can automatically control the duration and temperature of the heating element throughout a cooking cycle.

In some embodiments, a safety switch may be installed so as to automatically shut off power to the heating element and the motor if the cooking surface is removed from the housing.

In some embodiments, the control system allows various operational states of the apparatus. It may control the main power to the system. It may control the heating element and/or may allow the user to select the temperature at which they want to cook their food. It may control the speed at which the stirring paddle will rotate. It may have timers associated with the heating element and/or the paddle so that durations for cooking and stirring may be set either synchronized or independently of each other.

In some embodiments, the control system may allow for various stirring speeds. In some embodiments, the control system may allow for a stir-stop method, where the paddle will quickly scoop up and stir the food in, generally, one full 360° rotation, and then pause for a time to allow the food time to sear and cook on the heating surface. In some embodiments, the duration of the pause can be lengthened or shortened, depending on user preferences and what type of food is being cooked. Also, the direction of rotation of the paddle may be reversed within a given cooking cycle, if desired.

In some embodiments, the control system may have a memory to store cooking codes and a processor that can operate the cooking device in accordance with instructions associated with a particular cooking code. The control system may have a control panel that includes a user input to allow a specific code to be entered for a certain type of meal being prepared. This code may be associated with automatic control settings for, among other things, the temperature of the cooking surface, the turning speed and/or frequency of the paddle, and/or the duration for which the food is cooked. The code may vary depending on the type of food being prepared, and whether it is fresh, pre-cooked, frozen, raw, and so forth.

In some embodiments, pre-packaged food is provided for purchase by the device user. In some embodiments, the pre-packaged food may be labeled with the code to be entered for automatic cooking in the device.

### BRIEF DESCRIPTION OF THE DRAWINGS

FIG. 1a is a perspective view of a container with an integrated, horizontal stirring system.

FIG. 1b is an exploded view of one embodiment of a self-stirring assembly.

FIG. 2 is a perspective view of one embodiment of a self-stirring assembly.

FIG. 3 illustrates one embodiment of a mechanical drive train for a self-stirring assembly.

FIG. 4 illustrates one embodiment of a pinch-clip connector on the end of a paddle and how it may connect to a drive shaft.

FIG. 5 illustrates one embodiment of a snap-fit connector on the end of a paddle and how it may connect to a drive shaft.

FIG. 6 illustrates one embodiment of a quick-release connector on the end of a paddle and how it may connect to a drive shaft.

FIG. 7 illustrates one embodiment of a set-screw connector on the end of a paddle and how it may connect to a drive shaft.

FIGS. 8a-8d illustrate various alternate embodiments of a container in a self-stirring assembly.

FIGS. 9a-9d illustrate various alternate embodiments of a paddle in a self-stirring assembly.

These and other features will now be described with reference to the drawings summarized above. The drawings and the associated descriptions are provided to illustrate embodiments of the invention and not to limit the scope of the invention. Throughout the drawings, reference numbers may be re-used to indicate correspondence between referenced elements. In addition, the first digit of each reference number generally indicates that figure in which the element first appears.

### DETAILED DESCRIPTION OF THE PREFERRED EMBODIMENTS

Systems and methods which represent one embodiment of an example application of the invention will now be described with reference to the drawings. Variations to the systems and methods which represent other embodiments will also be described. Other variations and implementation details of the systems and methods will be apparent to those skilled in the art in view of the disclosure contained herein, along with the general knowledge in the relevant art.

Embodiments of the present invention concern improvements in cooking food. More particularly, embodiments include systems and methods for automatically cooking food to minimize the effort required of the user to prepare the meal as compared to conventional manual methods.

### 1. Overview

Embodiments of the invention include a container for food that has an integral stirring device attached to it. Because it is advantageous to be able to turn food over, a horizontal axis-based food stirring system may provide certain advantages, such as lifting food up and flipping it over. A container with a horizontal stirring system may have applications ranging from cooking devices to other containers where automatic stirring of food is desirable. For example, it may be used in a salad or serving bowl where the food needs to be stirred, but the user would find it more convenient to have the stirring device as an integral part of the bowl and to have it stir about a horizontal axis in order to, for example, turn over food. It may also be used in storage or mixing containers where a horizontal stirring motion would be preferred over using a traditional mixing spoon. It may also be used in an automatic cooking device.

A stirring paddle may be easily interchangeable with other styles and shapes of paddles in order to afford the user the ability to alter the utility of the bowl, container or cooking device to their desires. With a horizontal axis-based cooking device, the user may be able to not only cook stir-fry meals, but also cook other types of fried foods, along with soups or sauces, for example. Moreover, easy removal of the stirring paddle, or stirrer, permits easy cleaning of the container or cooking device.

In some embodiments, a control system is provided control certain aspects of the cooking device. The control system may be capable of automatically carrying out a cooking cycle including controlling the cooking duration, temperature and controlling the operation of the paddle through control of the motor (170). It may have timers associated with the heating element and/or the paddle so that durations for cooking and stirring may be set either synchronized or independently of each other. Manual operation of the cooking device features may also be permitted, alone or in combination with automatic operation. To keep food preparation easy, the control system for the cooking device may also accept cooking codes. In some embodiments, these cooking codes may be related to the type, quantity and/or condition of the food being cooked, wherein the condition may be any one of frozen, raw, pre-cooked, thawed, combinations of the same, and so forth. In some embodiments, the control system may accept the code and then automatically adjust temperature, stirring speed and/or frequency and/or cooking duration to cook the food. In some embodiments, these cooking codes may be provided with pre-assembled meals that the user purchases at the store. In some embodiments, the pre-assembled meals may be unique to the cooking device, in that they may be designed and tested specifically for proper and thorough automatic cooking of the food in the device. In some embodiments, the cooking codes may be licensed to multiple prepared food companies to develop meals for the cooking device. The control system preferably includes suitable components and programming to permit the operations described herein. For example, the control system may include memory for storing cooking codes and cooking protocols associated with the cooking codes. The control system may also include a processor for processing the protocols stored in the memory and outputting control signals to the elements of the device, such as the heating element (120) and the drive mechanism (170). The processor may also receive inputs from the control panel (180), such as user input of cooking codes, for example. Other suitable arrangements and features apparent to those skilled in the art may also be used.

Additionally, to keep within the spirit of making the food preparation experience easy and convenient for the user, the device may be disassembled for cleaning, and afterwards reassembled for use. For example, the bowl, stirrer and lid may be removable from the base housing to permit cleaning. One skilled in the art will appreciate many suitable embodiments for a connector that holds the paddle onto a stirring drive shaft to facilitate removal and/or assembly.

Thus, it is desirable to have a device which can be used to stir food about a horizontal axis. Additionally, when applied to a cooking device, a horizontal axis-based food stirring system may automatically and effectively cook food, while requiring less effort on the part of the user.

### 2. Description of Embodiments of Self-Stirring Assemblies

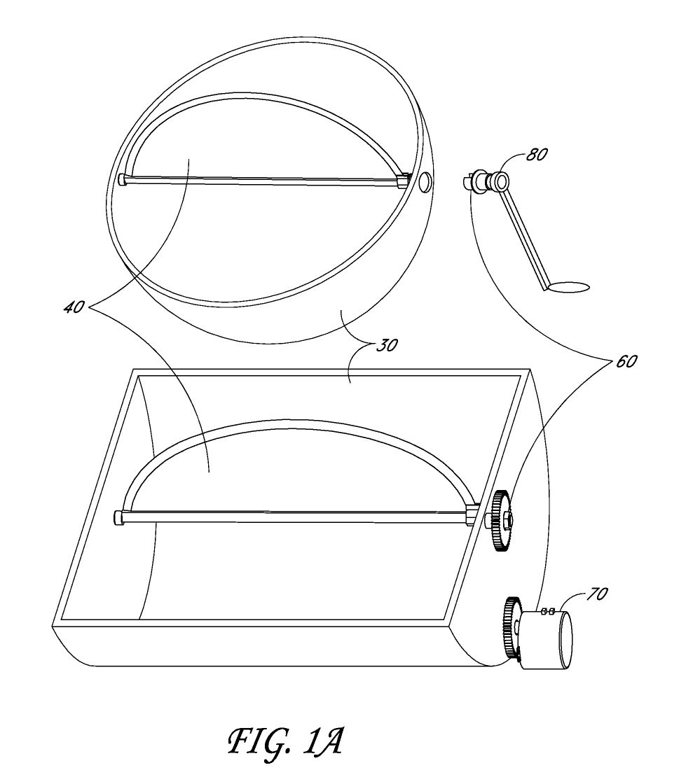

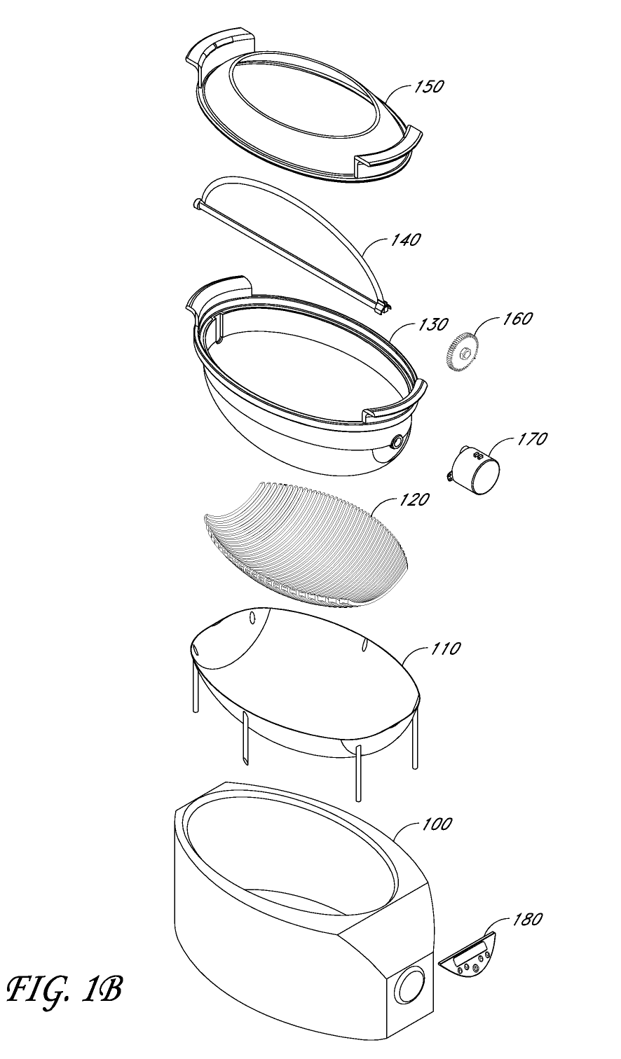

Referring now to FIG. 1 a, a pair of embodiments are illustrated in which a container (030) includes a paddle (040), a driveshaft (060), and either a motor (070) or a crank (080). It will be appreciated by one skilled in the art that other suitable embodiments of a container may include various combinations of the aforementioned elements. In the illustrated embodiment, the paddle (040) is mounted on the inside of the container (030) to restrict lateral motion, provide vertical structural support, but still allow rotational motion. In the illustrated embodiment, the paddle (040) is connected to the driveshaft (060), which is mounted to the container (040) in such a manner as to minimize leakage of liquids from the food contained therein. In the illustrated embodiments, the driveshaft (060) may be turned manually by a crank (080), or it can be connected to a motor (070) either directly or through a gear train, as shown. In the embodiment shown above, the container (030) is spherical in shape. In the alternative embodiment shown below, the container (030) is cylindrical in shape. Although not shown, a lid may be provided with the containers, which match the shape of the container (030).

Referring now to FIG. 1b, a second embodiment is illustrated in which a base housing (100) supports a heat shield (110), a heating element (120), a concave or rounded cooking surface (or bowl) (130), and a lid (150). It will be appreciated by one skilled in the art that other suitable embodiments of the device may include various combinations of the aforementioned elements. In the illustrated embodiment, the heat shield (110) is situated between the heating element (120) and the base housing (100). In the illustrated embodiment, the heating element (120) is sized and shaped in such a way as to maximize surface contact between itself and the rounded cooking surface (or bowl) (130). The heating element (120) preferably covers a substantial entirety of an exterior surface of the bowl (130) to ensure good heat transfer and an even temperature throughout the bottom wall of the bowl (130). Both the heating element (120) and the bowl (130) may define a generally semi-cylindrical, semi-ovoid or semi-spherical shape, or other suitable shape. The lid (150) and the bowl (130), combined, may define a generally cylindrical, ovoid or spherical shape, or other suitable shape. In addition, preferably, the heating element 120 is separate from the bowl (130) such that the bowl (130) can be easily removed and cleaned. In the illustrated embodiment, the upper portion of the bowl (130) maintains contact with the upper edge of the base housing (100) in order to provide stability. In the illustrated embodiment, the lid (150) sits on the upper edge of the base housing (100), and has handles which allow it to be easily removed by the user. In the illustrated embodiment, there are handles on the upper edge of the bowl (130) which allow for the user to pick up the bowl and remove it from the base housing (100).

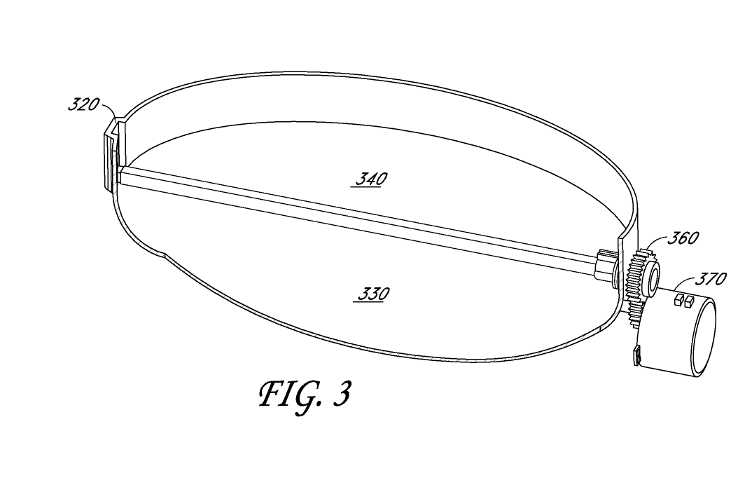

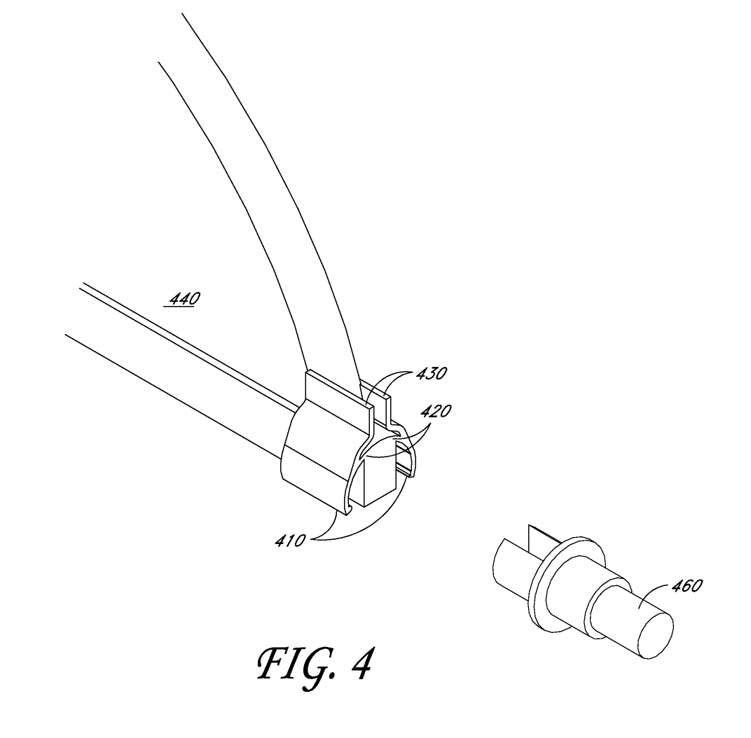

In the embodiment illustrated in FIG. 3, the paddle (140) is mounted inside of the bowl (130). One end of the stirrer or paddle (140) mates into a slot on one edge of the bowl (130) to restrict lateral motion, provide vertical structural support, but still allow rotational motion. The opposite end of the paddle (140) connects to the drive shaft (160) through methods as embodied in FIGS. 4, 5 and 6. In the illustrated embodiment, the drive shaft (160) mounts through an opening in the edge of the bowl (130). It may be sealed with the bowl (130) to minimize leakage of fluids while cooking, but still allow rotational motion. In the illustrated embodiment, the end of the drive shaft (160) that is not attached to the paddle (140) holds a gear which connects with the motor (170). The motor (170) is mounted internally to the base housing (100), and has a geared output shaft. The gear on the output shaft of the motor (170) meshes with the gear on the driveshaft (160), providing the drive train necessary for transferring the motion of the motor (170) to the paddle (140).

The mounting, orientation and geometry of the gears on the drive shaft (160) and the motor (170) may be arranged such that the gears automatically come into proper operational contact when the bowl (130) is placed into the base housing (100). Alternatively, the gears may be moved into contact with one another after the bowl (130) is placed into the base housing (100).

The control panel (180) is mounted on the external surface of the base housing (100) in suitable ways, such that it may be accessed and viewed by the user. Preferably, the control panel (180) displays relevant information of the cooking device and includes a user interface to allow cooking codes, or other information, to be input into the cooking device. Information displayed may include on/off status, cooking temperature, cooking time remaining, current cooking code and other suitable information.

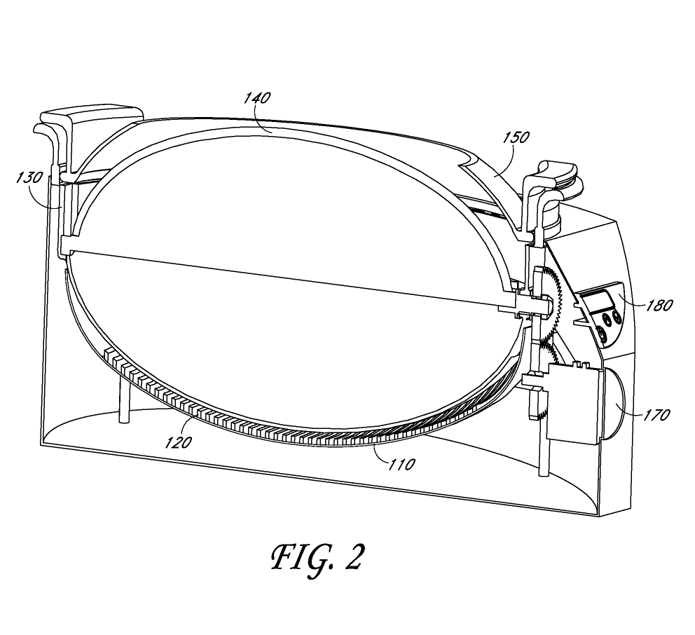

The embodiment as described in FIG. 1b can be seen in assembled form in FIG. 2. Preferably, the heat shield (110), heating element (120) and the drive mechanism (such as a motor 170) are assembled to the base housing (100) in a relatively permanent manner. That is, these components are not intended to be disassembled by the end user of the device. Although, such components may be capable of disassembly for repair or servicing of the cooking device.

### 3. Description of Drive Members

FIG. 3 displays a cutaway view of one embodiment of the bowl and how the drive system and paddle may fit within it. In the illustrated embodiment, the paddle (340) connects to the driveshaft (360) on one end and rests in the bowl guide (320) in the other end. The bowl guide (320) restricts motion of the paddle to rotational motion. In the illustrated embodiment, the driveshaft (360) protrudes through the bowl (330) and connects with the drive mechanism, such as the motor (370), to receive its drive motion.

### 4. Description of Paddle to Drive Shaft Connector

One skilled in the art will appreciate that there are a myriad of suitable manners in which to design the connector that attaches a paddle to a drive shaft. It may be advantageous have one that is user-friendly. Thus, in some embodiments, the paddle is easy to remove and install whether hot (just after cooking) or at room temperature. Certain embodiments accomplishing this objective are shown in FIGS. 4, 5, 6, and 7.

FIG. 4 displays one embodiment of a “compliant mechanism.” A compliant mechanism may be a single piece of pliable material, such as plastic or thin metal, that is formed in such a way as to allow hinge-style motion between relative portions of the part. The single piece plastic casting or molded part, herein referred to as the Pinch Clip, is a single piece with four main features. In its nominal position it is shaped so that it connects with and grips the drive shaft (460) so that motion can be transferred to the paddle through the illustrated key and slot arrangement and the food will be stirred. It can be pinched so that it flexes and releases its grip from the drive shaft (460) and be removed from the assembly with the use of one hand and no additional tools.

In the illustrated embodiment, the tabs (430) are pressed inward with a pinching motion by the user. This induces a pivoting motion about the flex hinge (420) which causes an outward motion of the grips (410) away from the drive shaft (460). The backbone (440) provides the base structure that carries load from the drive shaft (460) into the paddle (440). Preferably, the grips (410) and the flex hinge (420) carry no load, other than assuring that the backbone (440) stays in contact with the drive shaft (460). Although a single piece mechanism is shown and preferred for simplicity, multi-piece arrangements may also be used. For example, the flex hinge (420) may be a separate member from the member that defines the key.

### 5. Description of Alternate Paddle to Drive Shaft Connectors

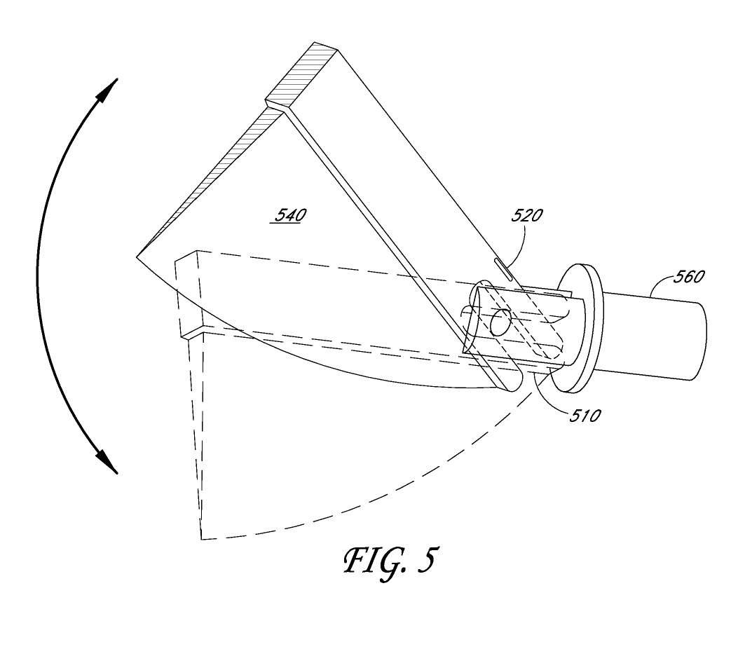

FIGS. 5, 6 and 7 display alternate embodiments for attaching a paddle to a drive shaft. In addition to the illustrated arrangements, other suitable coupling arrangements may also be used.

FIG. 5 displays one embodiment of a snap-fit arrangement for attaching the paddle (540) to the driveshaft (560). In the illustrated embodiment, the paddle (540) has a slotted end (510) and raised nubs (520) on the end. The driveshaft (560) matches the shape of the slotted end (510). The slotted end (510) of the paddle slides over the pin of the driveshaft (560). The paddle (540) is inserted at a downward angle onto the driveshaft (560) so that the opposite end is outside of the bowl while the connecting process begins. Once the slotted end (510) is resting firmly against the driveshaft pin, the paddle (540) is the rotated downward so that the end seats into the bowl (500). As the paddle is rotated into place, the nubs (520) are pressed through the driveshaft flange spreading the flanges apart until the nubs (520) reach the receptor slots cut into the driveshaft (560). The flanges then return to their original shape, enveloping the nubs (520) with the slots and locking the paddle (540) into place.

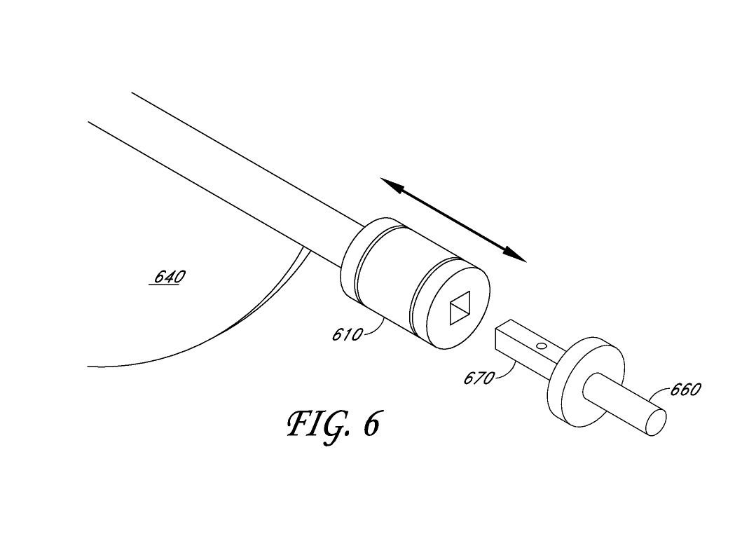

FIG. 6 displays one embodiment of a quick-release arrangement for attaching the paddle (640) to the driveshaft (660). The end is comprised of a sleeve (610) with an internal spring. The sleeve (610) and spring are assembled in such a way that the end of the sleeve is aligned with the end of the paddle. The sleeve (610) is pressed inwardly to compress the spring so that the end of the sleeve moves and exposes the mating end of the paddle so that it can be inserted into the mating key (670) of the driveshaft (660). Once they are mated, the spring is released from compression which moves the sleeve (610) back to its original position, covering the mating end of the paddle and the driveshaft so that they will not separate.

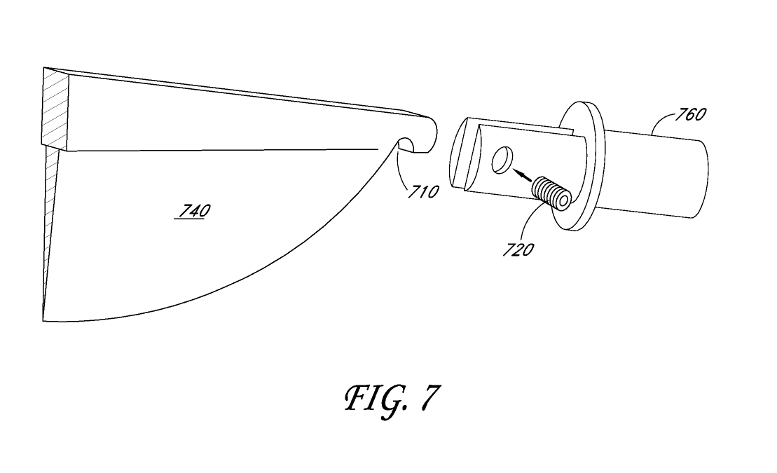

FIG. 7 displays one embodiment of a set-screw arrangement for attaching the paddle (740) to the driveshaft (760). The end of the paddle (740) has a slotted end (710). The driveshaft (760) matches the shape of the slotted end (710), and has a set-screw (720) in it. In the illustrated embodiment, the slotted end of the paddle is inserted into the driveshaft and the set-screw is tightened so that it locks the paddle in place.

### 6. Description of Alternate Bowl and Paddle Shapes

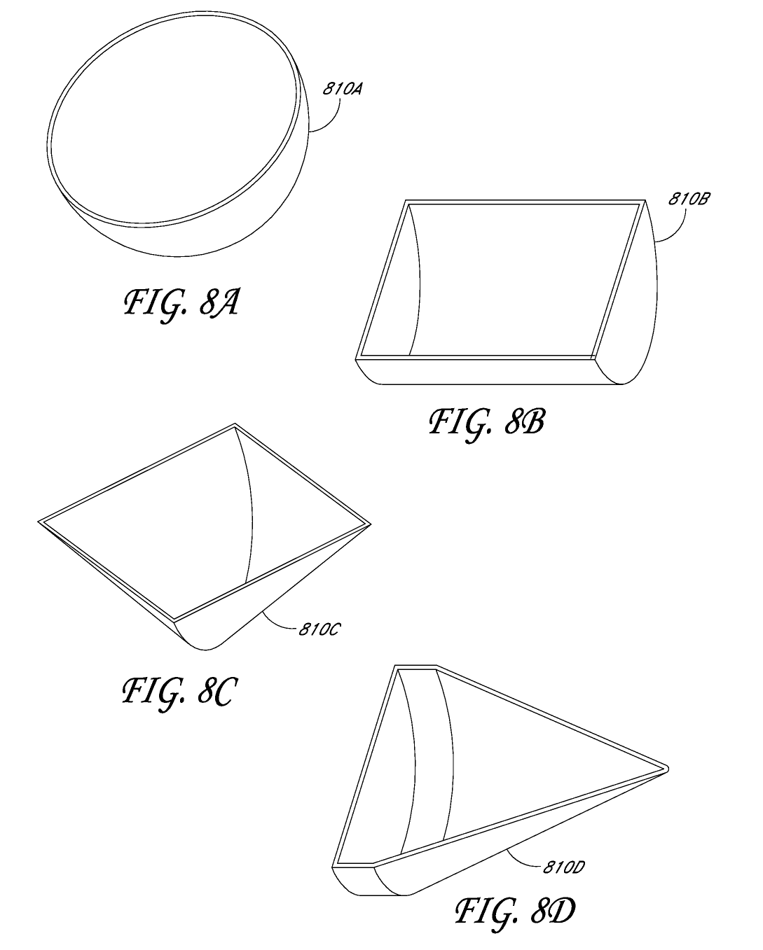

FIG. 8 shows various embodiments of a container. One skilled in the relevant art will appreciate that there are many suitable shapes that a container may take in the disclosed embodiments. In each variance of bowl shape (810a, 810b, 810c, 810d), the profile of the accompanying paddle may be shaped to match the bowl. The intent of FIG. 8 is not to show all possibilities of bowl shapes, but to show general deviations from the original.

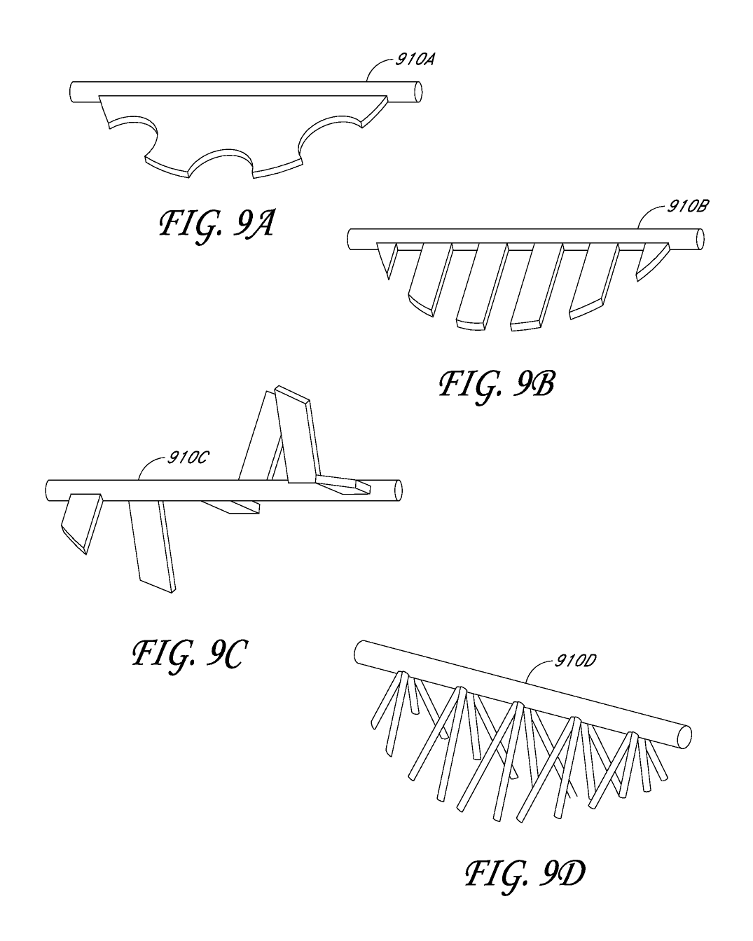

FIG. 9 shows various embodiments of a paddle. One skilled in the relevant art will appreciate that there are many suitable shapes that a paddle may take in the disclosed embodiments. In each variance of paddle shape (910a, 910b, 910c, 910d), the profile of the paddle may match the contour of the interior surface of the bowl. The intent of FIG. 8 is not to show all possibilities of paddle shapes, but to show general deviations from the original.

While certain embodiments of the invention have been described, these embodiments have been presented by way of example only, and are not intended to limit the scope of the present invention. It will be understood by those skilled in the art that the present invention extends beyond the specifically disclosed embodiments to other alternative embodiments and/or uses of the invention and obvious modifications and equivalents thereof In particular, while the present food cooking or stirring device has been described in the context of particularly preferred embodiments, the skilled artisan will appreciate, in view of the present disclosure, that certain advantages, features and aspects of the systems and methods may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A food cooking device, comprising:
a base housing defining an interior space;
a heating element within the interior space, the heating element providing a source of heat for cooking food;
a bowl that is separate from the heating element and is positionable into the interior space with the heating element between the base housing and the bowl, the bowl having a concave bottom wall defining an exterior surface and an interior surface, the interior surface defining a food space for receiving food for cooking, the bowl further having an upper rim defining an opening to the food space;
a lid that cooperates with the bowl to close the opening to the food space;
a stirrer that is positionable within the food space, the stirrer rotatable within the food space about a substantially horizontal axis.

2. The food cooking device of claim 1, further comprising a heat shield positioned between the heating element and the base housing.

3. The food cooking device of claim 1, wherein the heating element has a curved shape that approximates the shape of the exterior surface of the bottom wall of the bowl.

4. The food cooking device of claim 3, wherein the heating element is sized to cover a substantial entirety of the exterior surface of the bottom wall of the bowl.

5. The food cooking device of claim 3, wherein the heating element is generally a semi-ovoid or a semi-spheroid shape.

6. The food cooking device of claim 1, further comprising a drive mechanism coupled to the stirrer, the drive mechanism configured to transmit a rotational motion to the stirrer.

7. The food cooking device of claim 6, wherein the drive mechanism is capable of being disassembled from the stirrer.

8. The food cooking device of claim 7, further comprising a drive shaft extending between and coupling the drive mechanism to the stirrer.

9. The food cooking device of claim 8, wherein the drive shaft is coupled to the drive mechanism through a gear train.

10. The food cooking device of claim 8, wherein the drive shaft extends through the bowl.

11. The food cooking device of claim 8, wherein the drive shaft is releasably connected to the stirrer to permit the drive mechanism to be disassembled from the stirrer.

12. The food cooking device of claim 11, wherein the stirrer comprises a key portion and movable hinge portion and the drive shaft comprises a slot that receives the key portion, wherein the hinge portion normally locks the stirrer to the drive shaft and is movable to allow the stirrer to be released from the drive shaft.

13. The food cooking device of claim 1, further comprising a control system that controls the operation of the heating element and drive mechanism.

14. The food cooking device of claim 13, wherein the control system is configured to receive a control code that identifies a predetermined operational schedule for the heating element and drive mechanism.

15. The food cooking device of claim 1, wherein the stirrer comprises a continuous stirring surface that follows the shape of the interior surface of the concave bottom of the bowl along a substantial entirety of the length of the bowl in a direction along the horizontal axis.

16. The food cooking device of claim 1, wherein the stirrer comprises an interrupted stirring surface that follows the shape of the interior surface of the concave bottom of the bowl in a direction along the horizontal axis.

17. A method for automatically cooking food, comprising:
providing a particular cooking code associated with a particular food to be cooked;
providing an automatic food cooking device, the cooking device having a housing, a heating element, a bowl, a lid and a stirrer, wherein the heating element and the bowl are positioned in an interior space of the housing, wherein the lid closes the bowl and the stirrer is positioned within the bowl and is rotatable about a generally horizontal axis by a drive mechanism; and
providing the automatic food cooking device with a control system, the control system storing a plurality of cooking codes in a memory, the cooking codes containing a control schedule for operating the heating element and the drive mechanism, wherein the control system executes a particular control schedule in response to the particular cooking code being entered into the control system.

18. The method of claim 17, wherein the particular food is provided within a container, wherein the particular cooking code is provided on the container.

19. The method of claim 17, wherein the particular cooking code is related to a type, quantity or condition of the particular food.
